(19) United States
(12) Patent Application Publication
(10) Pub. No.: US 2016/0270371 A1
(43) Pub. Date: Sep. 22, 2016

(54) TRANSPARENT GLOBE PET TOY

(71) Applicant: WORLDWISE, INC., Novato, CA (US)

(72) Inventors: Charles Floyd, Oakland, CA (US); Victoria Davila, San Francisco, CA (US); Hannah Rosenberg, San Francisco, CA (US)

(21) Appl. No.: 15/156,762

(22) Filed: May 17, 2016

Related U.S. Application Data
(63) Continuation of application No. 14/660,686, filed on Mar. 17, 2015.

(51) Int. Cl. A01K 15/02

(52) U.S. Cl. CPC A01K 15/025

(57) ABSTRACT

A pet toy having a substantially spherical transparent upper housing and substantially spherical lower housing. Within the lower housing is a motor and power source. The motor has a shaft extending vertically from the substantially spherical lower housing to the substantially spherical transparent upper housing, and a plurality of fan blades that are fixed to the shaft such that upon rotation, the fan blades direct air toward the substantially spherical lower housing. The substantially spherical transparent upper housing is also provided with at least one opening located at its top when the toy is at rest and a plurality of attractants each of a mass and size to randomly circulate within the substantially spherical transparent upper housing upon energizing the motor, the at least one opening being of sufficient size to enable attractants to randomly escape the interior of the sphere when the fan operates but is too small to enable a pet to access the sphere's interior.

### RELATED APPLICATIONS

The present application is a continuation-in-part of U.S. patent application Ser. No. 14/660686, filed on Mar. 17, 2015.

### TECHNICAL FIELD

The present invention is directed to a pet toy specifically intended to captivate and intrigue cats. Activation of this device causes the toy to wobble as attractants vigorously move within a transparent globe causing the cat to swipe at the globe and to pounce upon those attractants which randomly escape its confines.

### BACKGROUND OF THE INVENTION

Although it is commonplace to leave cats alone within one's home for extended periods of time, they can oftentimes become bored resulting in potentially destructive behavior. Cats also have the instinctive need to swipe and pounce on prey and many pet toys intended to be used by cat owners rely upon this inherent behavioral characteristic by causing an attractant to move hoping that a cat will become engaged, thus satisfying its need to swat and pounce upon prey and to alleviate boredom. However, many of such devices are complex and move an attractant in a predetermined consistent fashion. In doing so, a cat will, although initially intrigued, eventually become bored as the motion of the attractant becomes constant and predictable.

It is thus an object to the present invention to provide a pet toy which is relatively simple to fabricate and robust in its ability to withstand engagement by an aggressive cat.

It is yet a further object of the present invention to provide a pet toy which presents to an engaged cat an attractant which is caused to move in an unpredictable and haphazard fashion thus maintaining a cat's interest for relatively prolonged periods of time.

These and further objects will be readily apparent when considering the following disclosure and appended claims.

### SUMMARY OF THE INVENTION

A pet toy comprising:
a substantially spherical upper housing, said upper housing being substantially transparent;
a substantially spherical lower housing joined to said upper housing;
a fan assembly extending between said upper housing and said lower housing, said fan assembly comprising a power source and motor energized by said power source located within said lower housing and having a shaft extending from said lower housing to said upper housing;
a plurality of fan blades fixed to said shaft, said fan blades residing within said upper housing such that upon rotation, said fan blades direct air toward said lower housing; said upper housing further comprising at least one opening located at its top when said toy is at rest and a plurality of attractants, each of a mass and size to randomly circulate within said substantially transparent upper housing upon energizing said motor, said at least one opening being of sufficient size to enable attractants to randomly escape the interior of said sphere when said fan operates but is too small to enable a pet to access said sphere's interior.

### BRIEF DESCRIPTION OF THE FIGURES

FIG. 1 is a perspective view of the pet toy of the present invention.

FIG. 2 is a schematic view of the fan assembly of the pet toy of the present invention.

FIG. 3 is a top view of the pet toy of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

Turning to FIG. 1, pet toy 10 is shown having substantially spherical transparent upper housing 11 and substantially spherical lower housing 12. Substantially transparent housing 11 is preferably fabricated of plastic and should be sufficiently transparent such that a cat sitting next to and gazing into it would see the ongoing activity (to be described hereinafter) and be somewhat mesmerized by it. Further, the toy's substantially spherical lower housing 12 residing upon surface 5 causes it to wobble when in use, both from the rotation of its motor shaft and fan but further from the anticipated swatting as the pet cat vigorously engages the toy. Pet toy 10 is characterized as having top 2 and a bottom 3 and motor 19 oriented vertically when at rest such that rotatable motor shaft 25 also extends vertically towards top 2.

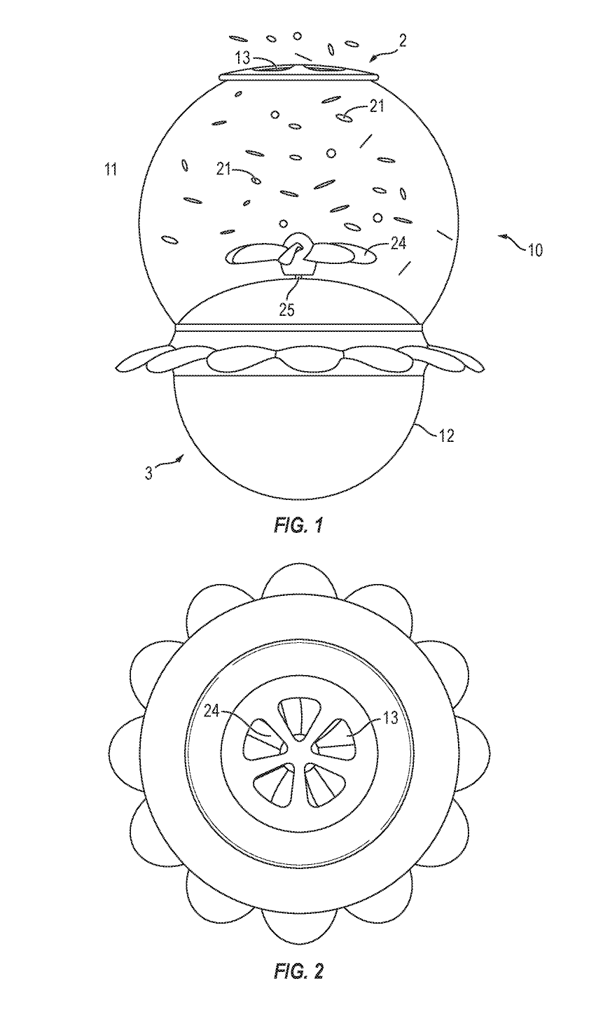

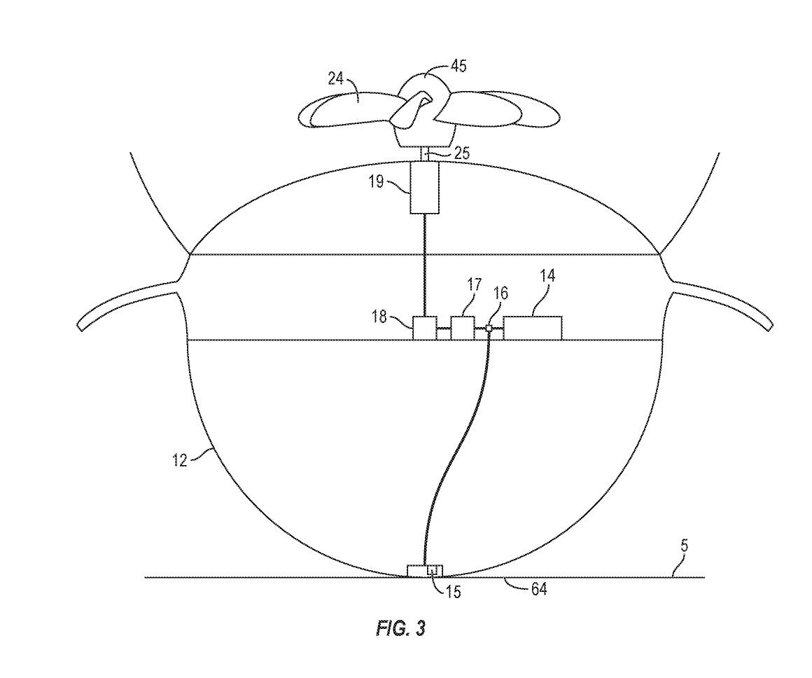

Fan assembly 12, best depicted schematically in FIG. 2, includes power supply 14, timer 17, integrated circuit 18 and motor 19, all housed in substantially spherical lower housing 12, power supply 14 being in the form of replaceable or rechargeable batteries. Fan 45 extends into substantially spherical upper housing 11 and is fixed to motor shaft 25 and is rotated such that blades 24, ideally in the shape of flower petals, cause air within substantially transparent housing 11 to move downwardly toward substantially spherical lower housing 12. This causes air movement within substantially spherical transparent housing 11 to suspend attractants 21 and cause them to move as more completely described below.

Pet toy 10 can be activated by switch 15 accessible by a user on the outer surface of pet toy 10, ideally at or about bottom region 3 which in turn activates controller 16. To enable a pet owner to simply activate pet toy 10 and allow his or her pet to use it without supervision, as a preferred embodiment, timer 17 is included which will interrupt power to motor 19 after the passage of a predetermined period of time. To also increase the attention grabbing and maintaining attributes of pet toy 10, integrated circuit 18 can be included to intermittently interrupt the energizing of motor 19 from power source 14 which enhances the cat's interest as it will ponder why the circulating attractants stop their haphazard motion within the sphere and restart randomly. Toy 10 also wobbles on surface 5 as motor 19 intermittently activates enhancing its movement and encouraging a pet cat to be more fully engaged.

The present invention contemplates the use of confetti 21 as attractants. Confetti is the attractant of choice as it is inexpensive, easily replenishable, and of extremely low mass generally composed of paper in the form of circular cutouts resulting in their rapid circulating motion when fan blades 24 are in operation and, when rotation of fan blades 24 are interrupted, confetti 21 immediately comes to rest at the bottom of the globe which stimulates the cat's curiosity and hunting instincts. Coupled with the toy's inherent wobbling motion, toy 10 has been found to be virtually irresistible to an engaged cat. When fan blades 24 are operating, confetti 21 immediately begins to circulate within the globe. As random pieces of confetti pass through openings 13 (FIG. 1), a cat will instinctively attempt to attack during vigorous play and increase the toy's wobbling motion. At the same time, openings 13 are sized to be small enough to prevent the cat from reaching within the interior of transparent housing 11 to prevent it from contacting the fan assembly to not only prevent injury to the cat but also to maintain fan integrity.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A pet toy comprising:
a substantially spherical upper housing, said upper housing being substantially transparent;
a substantially spherical lower housing joined to said upper housing;
a fan assembly extending between said upper housing and said lower housing, said fan assembly comprising a power source and motor energized by said power source located within said lower housing and having a shaft extending from said lower housing to said upper housing;
a plurality of fan blades fixed to said shaft, said fan blades residing within said upper housing such that upon rotation, said fan blades direct air toward said lower housing;
said upper housing further comprising at least one opening located at its top when said toy is at rest and a plurality of attractants, each of a mass and size to randomly circulate within said substantially transparent upper housing upon energizing said motor, said at least one opening being of sufficient size to enable attractants to randomly escape the interior of said sphere when said fan operates but is too small to enable a pet to access said sphere's interior.

2. The pet toy of claim 1 further comprising a timer for stopping power to said motor after passage of a period of time.

3. The pet toy of claim 1 further comprising an integrated circuit for intermittently interrupting the energizing of said motor from said power source.

4. The pet toy of claim 1 wherein said its shape of said lower housing causes said toy to wobble when in use.

5. The pet toy of claim 1 wherein the combination of said fan speed, mass of said attractants and size of said opening promotes the random escape of attractants through said opening.

6. The pet toy of claim 1 wherein said fan blades are in the shape of flower petals.

7. The pet toy of claim 1 wherein said attractants comprise paper confetti.
